(19) United States
(12) Patent Application Publication
(10) Pub. No.: US 2026/0160562 A1
(43) Pub. Date: Jun. 11, 2026

(54) Systems and Methods For Remote Route Replication and Generation

(71) Applicants: Garrett Christensen, Provo, UT (US); Damon Young, Orem, UT (US); Nicholas Morrill, Orem, UT (US)

(72) Inventors: Garrett Christensen, Provo, UT (US); Damon Young, Orem, UT (US); Nicholas Morrill, Orem, UT (US)

(21) Appl. No.: 19/379,719

(22) Filed: Nov. 4, 2025

Related U.S. Application Data
(60) Provisional application No. 63/715,874, filed on Nov. 4, 2024.

(51) Int. Cl. G01C 21/34

(52) U.S. Cl. CPC G01C 21/3446; G01C 21/3484

(57) ABSTRACT

Systems and methods for users to plan routes may copy specified criteria based on input route data. The system may analyze route information inputted by users and utilize a route matching algorithm to suggest similar routes based on criteria such as distance, elevation gain, terrain type, and other user-specified parameters. The system may provide automated matching or manual matching, assisted by visual aids, to find the route that most closely matches the input file and needs.

### CROSS-REFERENCE TO RELATED PATENT APPLICATIONS

This application claims the benefit of and priority to U.S. Provisional Patent Application No. 63/715,874, filed on Nov. 4, 2025, the entirety of which is incorporated herein by reference for all purposes.

### TECHNICAL FIELD

This disclosure relates generally to remote route replication and generation.

### BACKGROUND

Traditional route generation and selection for activities such as hiking, running, biking, and/or driving is a difficult, resource-intensive, and lengthy process. Route selection plays a large role in the enjoyment and training effectiveness of these individuals. In many instances, individuals select routes while preparing for future events such as races. In other instances, individuals select routes to increase their fitness and enjoyment through exercise and friendly competition.

In preparation for future events, individuals may be limited in their access to the actual terrain of the event. For example, the individual may be located in a geographically distinct location from the actual route of the future event; the location of the actual route may have restricted access; traffic conditions may not be favorable at times other than the event (e.g., roads may not be blocked off); and/or seasonal conditions may not allow for traveling upon the actual route.

Traditional methods for route generation and selection are limited in functionality. Current methods for finding suitable routes for outdoor activities often involve manual search processes or limited filtering options, resulting in inefficiencies and frustration for users. At times, these filters are limited to generalizations such as “hilly” or “flat” while much more accurate information would make proper route selection possible. Because of the extreme number of possible routes in a network or trails or paths, traditional methods utilize excessive processing power which leads to increased latency between request and generation, and increased processing requirements.

Another limitation of conventional route planning tools is the inability to replicate and compare routes, particularly in terms of matching key metrics such as grade, elevation gain and loss, and terrain surface type. Some methods only rely on the popularity of routes or use preselected routes which limit the ability to find routes that will adequately prepare an individual for future events or allow them to accurately compare their performance on other routes, or the performance of others on dissimilar routes.

Users of conventional methods for route generation often seek to understand how the elevation gain and loss of a route compare to other routes, especially when preparing for future events, such as races where terrain and elevation profile play a critical role in performance.

### SUMMARY

The disclosed system for route creation, replication and comparison described herein allows for the creation of similar routes based on various types of data from a primary route input. The primary route input is then processed using different generation techniques and algorithms, later outputting the optimized replicated routes with similarity scoring and visualization.

The system receives structured input data containing route information such as a GPX file or unstructured data such as a verbal or textual description. The system then parses the input to extract attributes such as elevation changes, curvature intensity, and terrain types. By slicing the input data into distinct sections and comparing them with secondary sections from secondary datasets, the system uses a replication algorithm to identify seamless route connectivity, ensuring the generation of continuous replicated routes that closely match the desired criteria, while also meeting other specified preferences.

Depending on the input, the system may employ direct attribute matching, graph-based propagation, or heuristic search algorithms to generate one or more replicated routes that satisfy the desired attributes. Results are displayed with a map visualization, elevation profile, and similarity score, and users can refine outcomes manually or through iterative regeneration.

Furthermore, by using machine learning algorithms and neural networks, precise routes can be created out of extreme numbers of possibilities that prioritize route attributes based on user preferences. While also allowing for manual creation and adjustment, as well as the use of predictive visual aids, the system provides unparalleled route planning capabilities. This system represents an advancement in the field of route selection, offering users high levels of control and precision in their training or recreational endeavors.

### BRIEF DESCRIPTION OF THE DRAWINGS

FIG. 1: Illustrates the system architecture comprising a device, processor, servers, and databases.

FIG. 2: Illustrates the processor and data flow between the Input Processing, Replication, and Refinement Engines.

FIG. 3: Illustrates information that is included in both structured and unstructured input datasets as well as from where that information is extracted or processed.

FIG. 4: Presents a flowchart of the basic process of Input Processing Engine and Replication Engine.

FIG. 5: A visual of an elevation profile and terrain type illustrating the comparison of an input and replicated route.

FIG. 6: Illustrates how an input and replicated route can share route attributes but vary in distance.

FIG. 7: Presents a flowchart of a machine learning based replication method.

FIG. 8: Presents a flowchart of a propagation-based replication method.

FIG. 9: Illustrates a possible visual aid for route creation or replication.

### DETAILED DESCRIPTION

### System Architecture

This description provides detailed insights into one or more embodiments of the invention, supported by illustrative figures clarifying its underlying principles. While these embodiments exemplify various aspects and applications, the system's scope extends beyond any singular embodiment, encompassing numerous alternatives, modifications, and equivalents as defined by the claims.

Embodiments of the present description pertain to systems and methods for the generation and replication of routes. Embodied within this system is one or more processors, and a computer-readable, non-transitory storage medium comprising instructions that when executed by the one or more processors cause the one or more processors to execute a series of operations aimed at facilitating the route replication and comparison process.

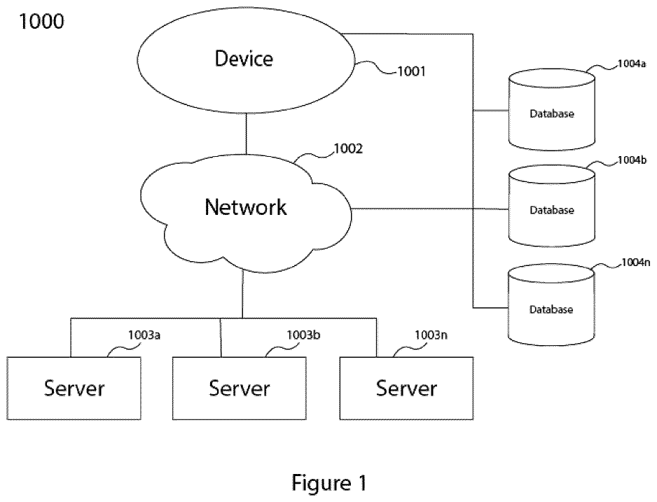

FIG. 1 depicts an exemplary system architecture 1000. Comprising of a device 1001, one or more servers (1003a, 1003b, . . . 1003n), and one or more databases or other storage devices (1004a, 1004b, . . . 1004n). Additionally, any data or information described as being stored in a database may also be stored locally on device 1001. This information includes map information, input and output datasets, and other application information necessary for operation.

In some embodiments, device 1001 could be any physical or virtual apparatus capable of performing specific functions as outlined in this description. Such devices may include, but are not limited to, computers, servers, processors, memory units, wearable devices, or any combination thereof. The term “device” encompasses hardware components, software applications, firmware, and any other elements necessary for the operation and execution of the disclosed processes and functionalities. Additionally, “device” may denote specific instances of hardware or software tailored to carry out tasks within the system, serving as components in the implementation and operation of the technology described herein.

Route information, such as street data, trail data, elevation, or location data, can be accessed from various sources. For instance, in one scenario, the device 1001 could access map data through online platforms like Internet websites, or applications hosted by servers (1003a, 1003b, . . . 1003n), databases (1004a, 1004b, . . . 1004n) or other connected computers via network 1002 (utilizing wired or wireless communication links). This information might be sourced from platforms like OpenStreetMap, Google Maps, Geographic Information Systems datasets (GIS), or similar providers.

In the context of this specification, the term “processor” encompasses a broad range of devices, circuits, and processing cores, all geared towards the processing of data, including, but not limited to, computer program instructions. This inclusive definition reflects the diverse array of technologies and architectures that can be employed to implement the system, underscoring its adaptability to various computational paradigms and hardware platforms.

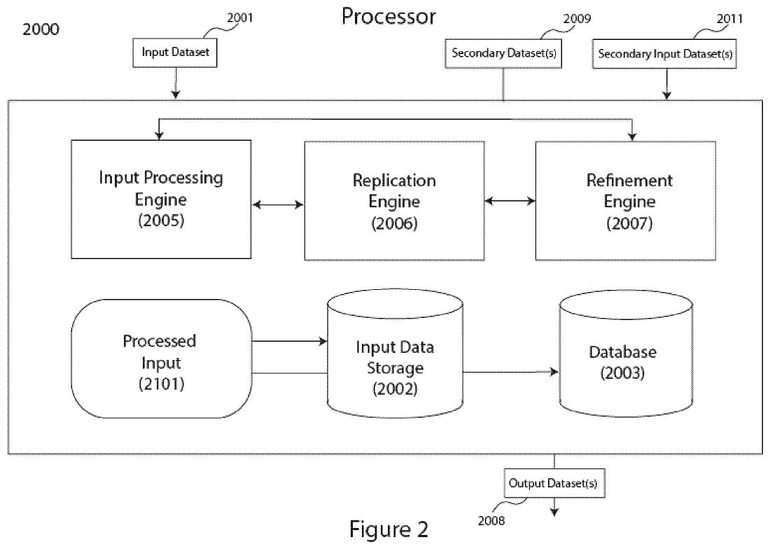

FIG. 2 is a diagram showing an embodiment of a processor in accordance with some embodiments. In one embodiment, the processor 2000 is equipped to receive an input dataset 2001 which could be stored locally in the input dataset storage 2002, a local database 2003, or externally in a database, or other storage devices (1004a, 1004b, . . . 1004n). In some embodiments, the input dataset 2001 is received as an external file uploaded to the device 1001. In some embodiments, the input dataset 2001 is received from a server (1003a, 1003b, . . . 1003n), database, or other storage devices (1004a, 1004b, . . . 1004n) connected to the device through a network 1002. In some embodiments, the processor 2000 contains an Input Processing Engine 2005, Replication Engine 2006 and a Refinement Engine 2007. Most commonly, the input dataset 2001 is received by the Input Processing Engine 2005, but in some embodiments, the input dataset 2001 is received from the processor itself through a Refinement Engine 2007 or the Replication Engine 2006.

In some embodiments, the processor 2000 is configured to receive one or more Secondary Datasets 2009 and one or more Secondary Input Datasets 2011. The processor is also configured to generate and output one or more Output Datasets 2008 typically containing one or more secondary routes containing one or more secondary route sections, each with secondary route attributes.

### Input Dataset and Processing

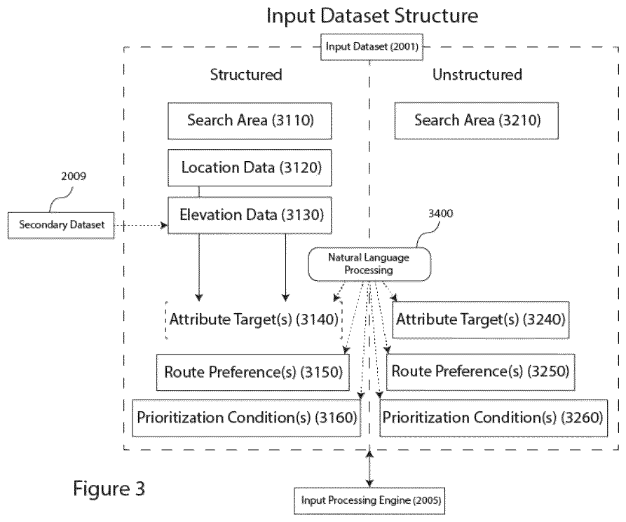

The input dataset 2001 contains route information of a primary route input and in this description, will now be referred to as the input 2001. FIG. 3 shows how the input 2001 is structured. In some embodiments, the input 2001 contains structured route data, Geographic Information System datasets (GIS), such as GPX or XML files or other GIS datasets. Structured route data includes, but is not limited to, a plurality of location and elevation nodes creating a route through geographical space. In some embodiments, the input 2001 contains unstructured route data, including, but not limited to, a sequence of one or more route attributes with no specific location or elevation.

In various embodiments the input 2001 includes one or more of the following data; one or more geographic search areas 3110, elevation data 3120, location data 3130, one or more Attribute Targets 3140, 3240, one or more Route Preferences 3150, 3250 and one or more Prioritization Preferences 3160, 3260, but is not limited to only this data.

Generally when the input 2001 is structured route data it includes a start point, end point, and a plurality of additional points forming a route, with each point including location, elevation, and terrain data. In some cases said route may be a course that a race will follow, a route that an individual is training to complete, for example, the route to traverse the Grand Canyon, a route that another individual completed, or a route an individual doesn't have easy access to.

### Route Attributes

Included in the Input 2001 are metrics or attributes of a route or particular section of a route typically pertaining to geographical or topographical aspects. These attributes play a role in defining and describing various elements of the route. For the remainder of this description these metrics or attributes will be referred to as route attributes. Route attributes frequently are described by one or more Route Attribute Targets, or target ranges, which is a quantitative way of describing said route attributes. Examples of route attributes include, but are not limited to;

Distance; This route attribute refers to a measurable separation between two geographic coordinates or spatial points, or a cumulative sequence of a plurality of geographic coordinates or spatial points.

Positive Elevation Grade; This route attribute represents the upward slope or incline of a route section, indicating the degree of ascent over a specified distance. It provides information about the elevation gain experienced along the route.

Negative Elevation Grade; Conversely, negative elevation grade denotes the downward slope or decline of a route section, reflecting the degree of descent over a given distance. It highlights changes in elevation and descent along the route.

Terrain Surface Type; This route attribute describes the nature of the ground or surface encountered along the route, such as paved roads, dirt trails, rocky paths, or off-road terrain. It helps characterize the terrain conditions and technicality of the route.

Elevation; Elevation refers to the height or altitude above sea level; it provides insight into the vertical position of the route segment and influences factors like difficulty level and oxygen levels.

Terrain Technicality; Terrain Technicality measures the difficulty associated with travelling on a path or route. Terrain Technicality is influenced by, but not limited to, surface irregularity, slope variability, step-height frequency, obstacle frequency (e.g., rocks, roots), and grade discontinuity.

Curvature Intensity; Curvature Intensity indicates the degree of curvature or bendiness of a route section, measuring the extent to which the route deviates from a straight line. It reflects the complexity of the route's path and influences factors like navigation ease and vehicle handling

In the case of a structured input, route attribute target(s) 3140 may need to be extracted from the Location Data 3120 and Elevation Data 3130. In the case of an unstructured input route attribute Target(s) 3240 could be more explicitly defined, such as with a specific route attribute target or target range, or with Natural Language Processing (NLP) 3400 of verbal or textual input. For example, “Find a route about 9 miles long that has rolling hills with an average of 10% grade up and down”. Verbal and textual inputs will be further described later in this description. Structured input may also use NLP 3400 to process or refine input route attribute target(s) 3140. Additionally, included in input 2001 will be one or more geographic Search Areas 3110, 3210 within which the Output Dataset 2008 will be defined.

Input Processing Engine 2005 is configured to access the input 2001 and parse said dataset to extract and process one or more route attributes, including but not limited to positive and negative elevation grades, terrain surface types, elevation, and curvature intensity of route sections. In some embodiments, Input Processing Engine 2005 is configured to access the local storage 2002. In some embodiments, Input Processing Engine 2005 is configured to access external databases or other storage devices. In some embodiments, Input Processing Engine 2005 parses the input 2001 directly for route attributes.

### Route Preferences

In some embodiments, Input Processing Engine 2005 is configured to receive one or more Route Preferences 3150, 3250. A route preference refers to a parameter or set of criteria that influences the formation and selection of one or more replicated routes within the system. These preferences are customizable options that allow users to tailor the characteristics of generated routes to align with their specific needs and preferences. For example, a route preference may include specifying a preferred start location or a distance range for a start location for the route, indicating whether the route shares the same start and end location, or preferring only routes that do not share the same start and endpoints, also known as point to point routes. Additionally, preferences regarding the inclusion of turnaround points along the route or the repetition of one or more secondary route sections could be included. These preferences provide flexibility and control over the route replication process.

In the case of a structured input, Route Preference(s) 3150 may need to be extracted from the Location Data 3120 and Elevation Data 3130. In the case of an unstructured primary route input Route Preference(s) 3250 could be more explicitly defined such as with a specific route attribute target or target range, or with Natural Language Processing (NLP) 3400 of verbal or textual input which will be further described later in this description. Structured input may also use NLP 3400 to process or refine Route Preference(s) 3150.

### Prioritization Conditions

In some embodiments, Input Processing Engine 2005 is configured to receive one or more Prioritization Conditions (3160, 3260), which define how route attributes (3140, 3240) and preferences (3150, 3250) are weighted during route generation and replication. These conditions determine which route attributes, such as grade, elevation, distance, curvature, or surface type, should be prioritized when evaluating or constructing one or more replicated routes with matching secondary route attributes. By assigning higher priority to specific route attributes, the system ensures that the resulting route aligns with user objectives or training goals.

Prioritization conditions may be provided directly by the user, inferred from structured input data, or extracted from unstructured textual or verbal input using Natural Language Processing (NLP) 3400. For example, if a user specifies “find a mostly trail route with steep climbs and then more mellow descents,” the system may automatically assign greater weight to elevation grade route attributes during route evaluation.

Prioritization conditions may be explicitly defined or implicitly defined such as in the case of replicating only one route attribute, it is inferred that the one route attribute receives the highest priority.

### Input Processing Engine Process

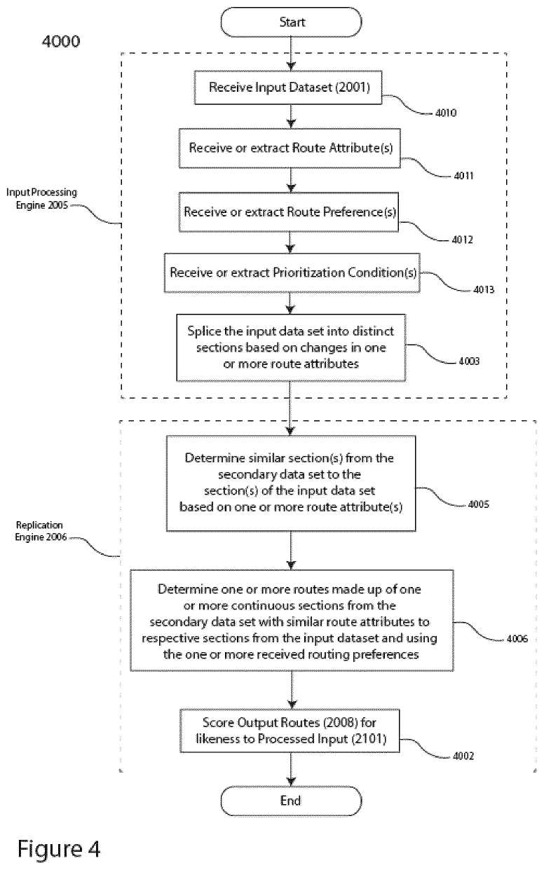

FIG. 4 shows a possible process the Input Processing Engine 2005 may implement. First by receiving the input 2001. This dataset may include one or more route attributes 4011, one or more Route Preferences 4012 and one or more Prioritization Conditions 4013. This information may also be extracted from the structured input 2001 (4011, 4012, 4013). In some embodiments, this extract is done by Natural Language Processing 3400.

In some embodiments, the system described is configured to receive and interpret one or more verbal or textual inputs. Inputs may include route attributes (3140, 3240), preferences (3150, 3250), prioritization conditions (3160, 3260) or other constraints. The verbal or textual input can express both quantitative or qualitative route attributes, such as distance, total elevation gain or loss, grade intensity, terrain type, or other route attributes. The route attributes may be described as a specific target or a target range and may describe the entire route as a whole or specific sections of the desired route. For example, an input in natural language form such as “Find me a route about twenty miles long where the first half averages fifteen percent uphill and the second half is slightly downhill.” The processor interprets this free-form input through a natural-language processing (NLP) module 3400 trained or configured to extract measurable route parameters from descriptive language. The NLP module 3400 may utilize rule-based parsing, keyword extraction, entity recognition, or machine-learning models to identify relevant features including numerical values (e.g., “twenty miles,” “fifteen percent”) and relational route attributes (e.g., “first half,” “downhill,” “slightly”).

### Input Parsing

In some embodiments, Input Processing Engine 2005 is configured to process the input 2001 in order to define route attributes. For example, Curvature Intensity is not a common route attribute explicitly defined or included in many GIS datasets. However, it can be derived from processing common data points such as geographical data. In other cases, if a positive or negative elevation grade is not included in the input dataset, then the Input Processing Engine could process the elevation data to extract the changes in elevation grade.

In some embodiments, Input Processing Engine 2005 can access multiple databases or other storage devices (1004a, 1004b, . . . 1004n) with the goal of combining different information from each one. For example, one dataset may include location data and elevation data while another includes location data and terrain surface type data. The Input Processing Engine 2005 would combine this information, aligning the location data with one or more other datasets such as elevation and terrain surface type data. In other embodiments, where the input 2001 does not include location data or elevation data but only includes route attribute and distance targets Input Processing Engine 2005 will only access location and elevation data of the Secondary Dataset 2009 within one or more geographic search areas.

In some embodiments, Input Processing Engine 2005 parses the input 2001 for variances in route attributes. A variance in route attribute denotes a notable alteration or divergence in particular characteristics within a section of a route, as contrasted with adjacent or preceding sections. These variances play a role in signaling transitions or adjustments in terrain conditions, elevation patterns, or other pertinent factors encountered along a route. Among the most prevalent variances are alterations in elevation grade, which may include uphill climbs, downhill descents, or stretches of flat terrain. Additionally, shifts in terrain surface type, ranging from smooth pavement to gravel paths or rocky terrain. Changes in curvature intensity such as when gentle bends in the route evolve into sharp turns or hairpin bends is another example. This is a non-exhaustive list but illustrates the concept of variances in route attributes. The significance of variances and the threshold of change vary but determine the frequency and location of slices the Input Processing Engine 2005 makes.

### Input Slicing

In some embodiments, Input Processing Engine 2005 is configured to slice the primary route input 2001 in accordance with some embodiments. Each route attribute will yield different slice locations, and Input Processing Engine 2005 may slice according to the received one or more route attributes. In some embodiments, Input Processing Engine 2005 is configured to prioritize certain route attributes over others when slicing based on one or more received prioritization conditions.

In some embodiments, Input Processing Engine 2005 is configured to receive a slicing threshold from an input on device 1001. In some embodiments, Input Processing Engine 2005 is configured to determine the slicing threshold based on the range of each route attribute across the entire route or a selected portion of a route. For example, if the max uphill grade of a route is 15% and the minimum downhill grade is 10% then the Input Processing Engine 2005 would not set the slicing threshold to changes above 20%, but something more appropriate such as 5%. Or if a route includes paved roads, gravel roads, and single-track trails. The slicing threshold for the terrain surface type route attribute could be set to slice at any change from paved surface to dirt surface, but may not make slices at a change from smooth dirt surface to rocky dirt surface.

Once slicing and processing is complete, the input 2001 will have one or more sections, each with corresponding metrics for one or more route attributes. This information, known as the Processed Input 2101 may be stored locally in a database 2003, Input Data Storage 2002, or on an external database or other storage device (1004a, 1004b, . . . 1004n).

### Route Replication

The Output Dataset 2008 usually will consist of a start point, end point, and in many cases a plurality of additional points forming a route, with each point including location, elevation, and terrain data. This Output Dataset 2008 will be referred to as replicated routes, or simply output 2008 for the remainder of the description. The system aims to generate one or more replicated routes by combining one or more secondary sections from the one or more secondary datasets whose one or more secondary route attributes, and one or more preferences correspond to the input 2001 within the geographic search area(s) (3110, 3210), into one or more continuous replicated routes. In many embodiments, the replicated route is in a different location from a structured input 2001. Replication Engine 2006 may use a plurality of methods described herein to achieve the desired Replicated route 2008.

In some embodiments, Replication Engine 2006 is configured to generate one or more output datasets or routes 2008, within the constraints of route preferences, that replicate the information provided in the Processed Input 2101, but in a different location and within the geographic Search Area(s) (3110, 3210). These replicated routes each have corresponding secondary route attributes and route preferences similar to the Processed Input 2101 from the Input Processing Engine 2005. Replication Engine 2006 is configured to generate replicated routes using replication algorithm 4000 which is illustrated in FIG. 4.

Replication Engine 2006 is configured to receive the Processed Input 2101 and access one or more secondary datasets 2009 (4001, 4002). This secondary dataset 2009 could be accessed from a server (1003a, 1003b, . . . 1003n), database, or other storage devices (1004a, 1004b, . . . 1004n) connected to the device through a network 1002. In some embodiments, the secondary dataset 2009 could be stored locally in a database 2003. The secondary dataset 2009 contains map information. In some embodiments, the secondary dataset 2009 is a database of map information or other GIS datasets. In various embodiments, the secondary dataset 2009 includes one or more of the following types of data; elevation data, location data, and terrain surface data, but is not limited to only these data types.

In general, the method for replicating a route is based on identifying and matching individual sections of the Processed Input 2101 with sections from one or more secondary databases 2009 of existing secondary sections and then combining these matched sections to form a continuous replicated route that closely resembles the original in its overall route attribute(s) (3140, 3240) and route preference(s) (3150, 3250). Each section is evaluated according to the received one or more route attributes, such as grade change, elevation, curvature intensity, terrain surface type, and distance, and potential matches are ranked according to their similarity to corresponding sections of the Processed Input 2101, and in some embodiments, based on the input of route attribute and preference priority. Once suitable matches are identified, the Replication Engine 2006 connects these sections in a sequence that preserves both logical path continuity and proportional distribution of route attribute(s) (3140, 3240) and route preference(s) (3150, 3250) of the Processed Input 2101. Multiple methods exist that can be used to determine which sections provide the best match and how they should be connected, including, but not limited to direct route attribute matching, graph-based propagation techniques, heuristic, such as Dijkstra's algorithm, A* pathfinding, or gradient-based cost functions, or optimization-based search algorithms, predictive machine leaning models, and hybrid combination methods that merge and score results from several approaches to produce the most accurate and efficient replication.

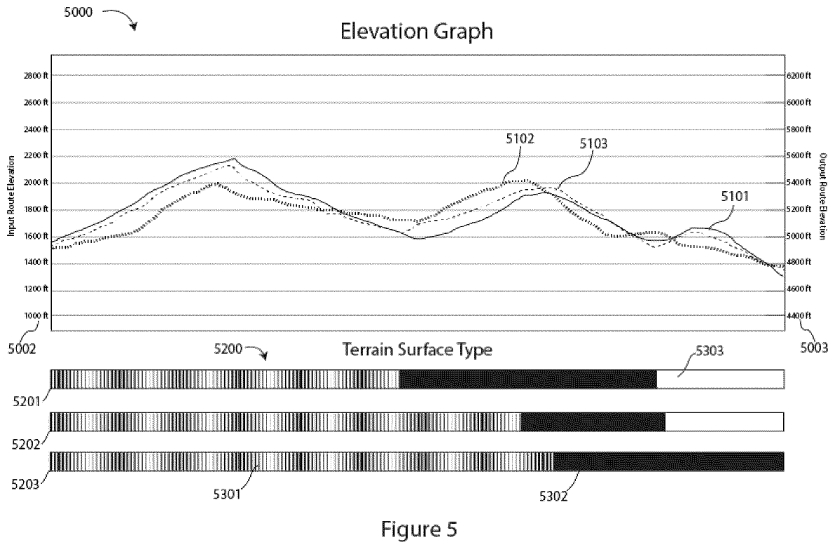

To further illustrate an embodiment of Replication Engine 2006, FIG. 5 shows an elevation graph 5000 of multiple elevation profiles. One profile is the elevation profile of a structured Input route 5101. If the Replication Engine 2006 is configured to replicate a route based on the route attributes of positive elevation grade and negative elevation grade. The elevation profile of the replicated route 2008 could be profiles 5102 or 5103. Note that they may not be exactly similar, but closely match profile 5101, with profile 5103 more closely matching. In this figure, the elevation chart 5000 also shows the altitude scale of the input route 5002 and the altitude scale of replicated route 5003. Also included in the FIG. 5 is a visualization of terrain surface type 5200. Each bar represents the terrain surface type along its corresponding elevation profile and route. (5101-5201, 5102-5202, and 5103-5203) In this example, the Replication Engine 2006 did not receive prioritization conditions for the route attribute of terrain surface type, thus the overall elevations of the input route 5101 and replicated route 5103 match closely, but the terrain surface type of input 5201 do not closely match that of replicated route 5203. The terrain surface type display 5201 shows what terrain surface type is for the input route while terrain surface type displays 5202 and 5203 show what terrain surface type is for potential replicated routes. Hash pattern 5301 could represent a paved surface; pattern 3302 could represent a dirt road and pattern 5303 could represent a technical trail. If Replication Engine 2006 had received prioritization conditions for the route attribute of terrain surface type above route attribute of elevation gain and loss than the best replicated route would have been that of 5102, 5202 because the terrain surface type 5202 more closely matches the input terrain surface type 5201.

Route Attribute Replication with Varying Distance

In some embodiments, Replication Engine 2006 is configured to replicate one or more route attributes in the replicated route but not match the overall distance of the input route. Replication Engine 2006 scales the magnitude or duration of individual route sections such that the replicated route maintains similar patterns and proportions of distance, grade, elevation change, or other route attributes to those of the input route but over a shorter or longer total distance. For example, when training for a running race that has a large amount of vertical gain in the beginning of the race and a small amount in the second half of the race, an athlete may want to have their training runs match this same sequence of grades. Thus, the replicated route would match the grades and sequence of grades, and proportion of grades to the overall distance of the input route, but in a shorter, more manageable training route. The same could be done for one or more route attributes-matching one or more secondary route attributes with the one or more route attribute targets, sequence of the one or more route attribute targets, and the proportional distribution of route attributes relative to overall route length.

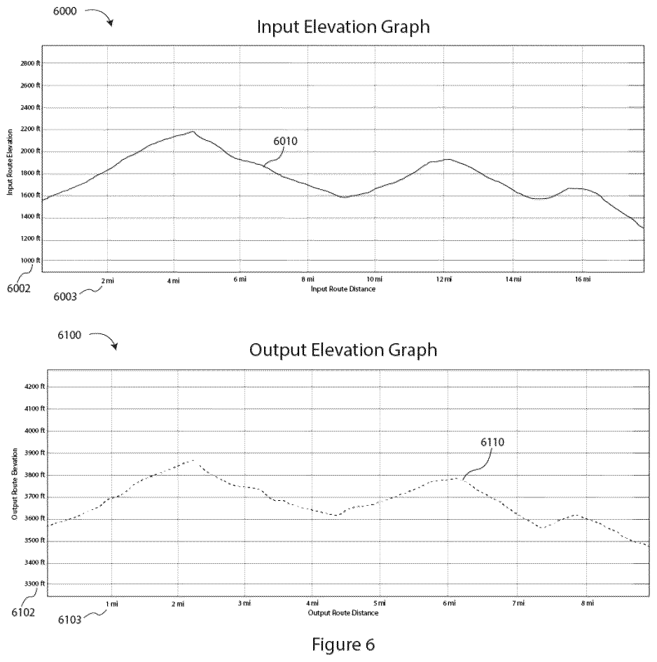

FIG. 6 illustrates this concept for the route attribute of elevation gain and loss. Input Elevation Graph 6000 and Replicated route Elevation Graph 6100 show the elevation profile of an input route and an replicated route generated by the disclosed system. Note the differences in the graph axis 6002, 6102 and 6003, 6103 respectively. The route profiles 6010 and 6110 share a similar sequence of elevation gains and loss as well as the grade of those gains and losses. However, the distances of the two routes differ significantly as shown in the distance axis' 6003 and 6103.

In some embodiments, Replication Engine 2006 is configured to calculate similarity scores representing proportional distribution of route attributes between the input and replicated routes.

### Replication Methods

The methods described herein represent various possible implementations for achieving route replication and are provided for illustrative purposes. These examples are non-limiting, and numerous alternative methods, algorithms, and computational techniques may be employed to accomplish substantially the same result without departing from the scope of the system.

### Direct Route Attribute Match Method

In some embodiments, route replication is performed through direct route attribute matching, in which the Replication Engine 2006 identifies route sections from stored datasets 2009 whose secondary route attributes closely align with those of the Processed Input 2101. Each section of the Processed Input 2101 is compared against one or more secondary route sections and one or more secondary route attributes such as distance, grade, elevation change, and terrain surface type. Matching sections that fall within tolerance thresholds are selected and combined to form a continuous replicated route that reflects the overall characteristics of the input. This is done by selecting continuous sections with matching route attributes that best fulfill the route preferences and prioritization conditions of the input route.

This technique is particularly effective when the number of sections requiring replication is relatively small or when the desired route can be represented by a limited set of key route attributes. Because each section is evaluated and matched independently, direct route attribute matching offers a computationally efficient approach suitable for localized replication tasks or for generating shorter routes with high route attribute fidelity.

With most replication methods, Replication Engine 2006 combines sections to generate one or more routes that replicate the Processed Input 2101, and calculates a similarity score and rank for said replicated routes.

### Machine Learning Method

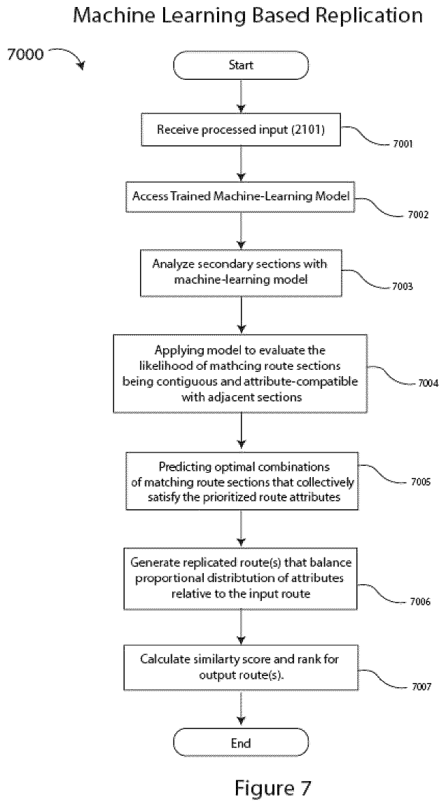

FIG. 7 illustrates possible steps Replication Engine 2006 may take to implement a Machine Learning Based Replication Method.

In some embodiments, Replication Engine 2006 is configured to replicate one or more route attributes simultaneously using or accessing machine learning models. Because a perfect replication across all route attributes is rarely achievable, especially when multiple route attributes are considered at once, neural networks and related models may be implemented and accessed to optimize both efficiency and accuracy 7002. These models can reduce the number of possible route combinations and route sections that must be evaluated by identifying route attribute relationships that naturally occur together within real-world terrain data.

For example, the model accessed by the system may learn that certain route attributes are more likely to appear in proximity to one another in physical terrain-such as steep, rocky surfaces occurring more frequently in high-altitude regions, while smooth dirt paths are less common in such terrain. Or certain curvature intensities found in switchbacks correlate to a certain range of elevation grades. By leveraging these learned correlations, the trained model accessed by the system narrows the search space, focusing computational effort on the most probable combinations of route sections 7003.

In some embodiments, Replication Engine 2006 is configured to generate one or more replicated routes by analyzing one or more secondary sections of one or more secondary datasets with the machine-learning model to identify correlations and dependencies between the one or more secondary route attributes of the one or more secondary route sections of the one or more replicated route and the one or more route attributes or the one or more route sections or the input dataset 7003. Applying the trained model to evaluate the likelihood of matching route sections being contiguous and route attribute-compatible with adjacent sections 7004. Predicting one or more optimal combinations of matching route sections that collectively satisfy the prioritized route attributes while maintaining geographic continuity 7005. And generating one or more replicated routes that balance proportional distribution of route attributes and topographic continuity relative to the input route 7006.

Replication Engine 2006 may deprioritize individual route sections that match extremely well in isolation but disrupt continuity or degrade similarity in adjacent sections. In most cases, the preferred replicated route is one where all sections match reasonably well across multiple route attributes rather than achieving near-perfect alignment in only a few. This approach increases overall replication quality while reducing processing time and computational demand. It also balances proportional distribution of route attributes and topographic continuity relative to the input route

In some embodiments, the machine-learning models used for replication are trained using training data that incorporate a broader range of route attributes, even when only a subset of those route attributes is being used in any single replication process 7002. This multi-attribute training approach enables the models to recognize and leverage correlations between secondary or supporting route attributes, improving predictive accuracy even when only a subset of route attributes is targeted for replication. As a result, the system benefits from a richer understanding of route composition, enhancing both the efficiency and the realism of the generated routes.

In some embodiments, the processor 2000 is configured to utilize reinforcement learning to improve the accuracy of route replication over time based on feedback from previous route replications. The reinforcement learning component may operate in conjunction with the Replication Engine 2006 and the Refinement Engine 2007, continuously updating internal model parameters in response to performance metrics observed from completed route replications. During each iteration, the system may compare predicted route similarity scores with actual user or device feedback data, such as deviation from the intended route, pace variation, traversal time, or user-provided quality ratings, and compute a corresponding reward signal indicative of replication accuracy. The reinforcement learning model may then adjust its policy or weighting functions governing the selection and combination of route attributes (e.g., grade profile, curvature pattern, terrain technicality, or environmental continuity) to maximize cumulative reward across future replications. Over successive iterations, this adaptive feedback mechanism enables the system to automatically refine its predictive models, enhancing its ability to generate routes that more closely match user intent, environmental constraints, and multi-attribute similarity targets. In some implementations, the learning process may utilize temporal-difference updates, policy-gradient optimization, or Q-learning techniques to balance exploration of new route attribute combinations with exploitation of previously successful replication strategies.

Similar to most replication methods, Replication Engine 2006 combines sections to generate one or more routes that replicate the Processed Input 2101, and calculates a similarity score and rank for said replicated routes 7008.

### Propagation (DNA Matching) Method

In some embodiments, route creation and replication is based on matching sections and combining sections of an input route with secondary sections from one or more secondary datasets 2009 to form a continuous replicated route exhibiting matching terrain route attributes. The Replication Engine 2006 accesses database 2003, Secondary Database(s) 2009 or external servers (1003a, 1003b, . . . 1003n), containing pre-processed route sections generated from previously ingested datasets. These stored sections include normalized representations of elevation change, curvature intensity, and surface type, enabling efficient comparison across diverse data sources.

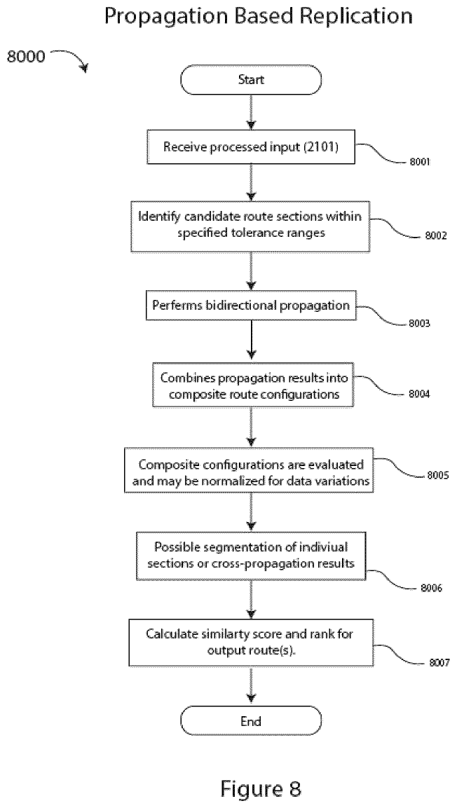

FIG. 8 shows a possible process 8000 used by Replication Engine 2006. Upon receiving the Processed Input 2101, 8001 the Replication Engine 2006 identifies matching route sections whose route attributes fall within specified tolerance thresholds 8002. The engine then performs a bidirectional propagation process through a graph-based route network 8003 from each identified matching route section, wherein each node represents a location with elevation and a section is a vector between two nodes and a plurality of connected nodes defines a route. Forward propagation and backward propagation extend along adjacent route sections meeting the tolerance thresholds for route attribute values until the accumulated propagated distance approximates that of the corresponding route section of the input distance.

The system then combines forward propagation results and backward propagation results through a cross-propagation process to generate route combinations that collectively represent potential matching routes 8004. Each composite configuration is evaluated using a weighted similarity score based on alignment of the replicated route section attributes with the input route section attributes. Normalization factors may be applied to account for sampling frequency or elevation noise 8005. This process, conceptually similar to sequence-alignment techniques used in DNA matching but adapted for geospatial data, enables the system to identify and align route segments based on structural and topographic similarity. The resulting similarity scores are aggregated and ranked to produce a similarity-ordered list of route matches which may be displayed to the user or stored for subsequent use.

In some embodiments, the Replication Engine 2006 and Refinement Engine 2007 is further configured to segment or crop individual sections or cross-propagation results into distinct route portions that meet cumulative distance thresholds corresponding to the input section length 8006. This cropping process ensures that overlapping or redundant segments are excluded and that each resulting portion represents a discrete and complete match candidate. Optionally, the system may enforce constraints to prevent inclusion of route sections that form closed loops, double back across previously traversed nodes, or satisfy other route preferences, thereby improving computational efficiency and the quality of final matches

Similar to most replication methods, Replication Engine 2006 calculates a similarity score and rank for said replicated routes 8007.

### Route Refinement

In some embodiments, the Refinement Engine 2007 is configured to process and enhance the replicated route generated by the Replication Engine 2006, enabling further alignment of the resulting routes with user preferences or system optimization. The Refinement Engine 2007 provides mechanisms for both automatic and manual adjustment of the route, allowing users to fine-tune aspects such as distance, elevation profile, terrain composition, or start and end locations. In certain cases, refinement may involve recalculating similarity scores or reranking replicated routes based on updated section and route similarity to the Input 2001. The refinement process can also include iterative regeneration, wherein modifications to the Input 2001 are reintroduced into the Input Processing Engine 2005 or Replication Engine 2006 to produce a new, optimized set of results. Through these functions, the Refinement Engine 2007 ensures that the final replicated route best satisfies the user's intended objectives.

In some embodiments Refinement Engine 2007 is also configured to measure the accuracy and similarity of the replicated routes of Replication Engine 2006 and to work in conjunction with Replication Engine 2006 to generate a more accurate replicated route 2008. A replicated route 2008 may be generated and refined multiple times until the replicated route 2008 is satisfactory, or further refinement isn't feasible.

### Visual Comparison Aid

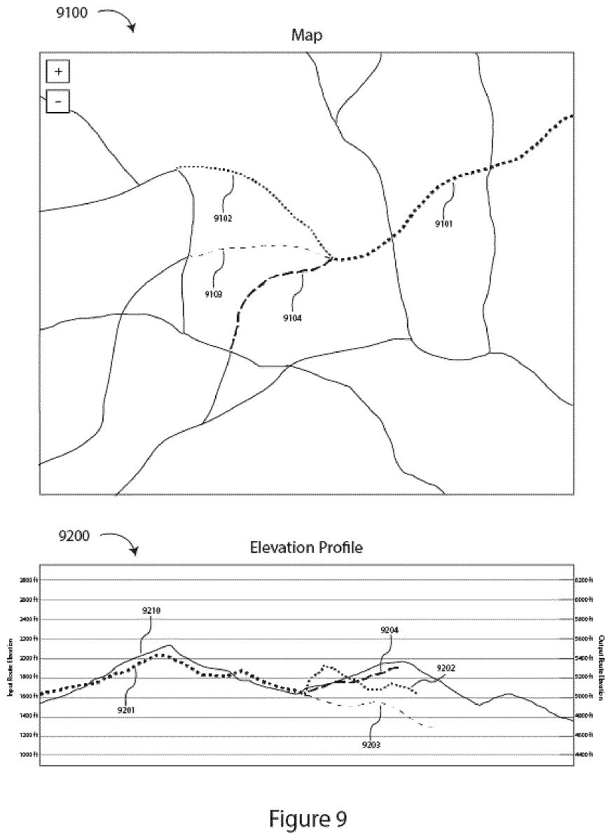

In some embodiments Refinement Engine 2007 is configured assist in route refinement by adjusting one or more replicated routes to further align with route attributes targets, preferences and prioritization conditions. Refinement Engine 2007 may also be configured to use manual routing modification to further refine a generated route. When manually modifying routes, a user can manually adjust a route until it is satisfactory. Refinement Engine 2007 provides a user with predictive visual aids to assist in the refinement of an replicated route. FIG. 9 shows an example of a possible visual representation. A map 9100 of an area is shown with multiple connecting trails. Route 9101 is a selected, but not completed route. In both Elevation Profile 9200 and Map 9100 it shows that route 9201 closely matches the input route 9210 up to a certain point where there is a fork in the route with various potential upcoming sections 9102, 9103, 9104. If a user is manually creating or adjusting a route, and one or more potential future sections of a route can be added to the existing route, those sections will display on the both the Elevation Profile 9200 and the Map 9100. This allows the user to easily see which section best matches the input route. In the case of the example in FIG. 5, it is clear that section 9104 (on map), 9204 (on Elevation Profile) is the section that best replicates the elevation profile. The display of upcoming section options can be done with one or more route attributes. The display of future section options can also be multi layered, meaning it can show upcoming section options after one or more upcoming section options.

### Format and Export Functionality

In one embodiment, the processor 2000 has an export functionality, wherein the replicated route 2008 may be exported to external devices, shared with other users, or used to compare personal performances with other users or athletes. In some embodiments, the processor 2000 is configured to format the replicated route dataset to include geographical coordinates, waypoints, elevation data, and other data compatible with GPS-enable devices including smartwatches, smartphones, bike computers and dedicated outdoor navigation devices. The exported route data may include key information such as waypoints, elevation changes and terrain types allowing users to easily follow the replicated route during their outdoor activities. Additionally, the processor 2000 is configured to format the replicated route to integrate with external mapping or fitness applications. In some embodiments the processor 2000 is configured to export the formatted replicated route to a computing device, smartwatches, bike computers, smartphones, or GPS-enabled devices as well as export the formatted replicated route to external mapping or fitness applications, enabling users to track their progress in real-time while following the replicated route.

### Use of Replicated Route.

In some embodiments, the generated replicated route 2008 and datasets generated by the processor, such as replicated routes, route attribute datasets, and similarity metrics, may be utilized for a variety of analytical, comparative, and training-based purposes. The replicated route 2008 and datasets generated by the processor may also be coupled with performance data from users on replicated routes. This performance data may include, but is not limited to, location, elevation, pace, heart rate, power body temperature and cadence data. These uses extend beyond route visualization to include applications in data modeling, athletic performance evaluation, performance comparison, and artificial intelligence training. What follows are examples of possible uses of system outputs coupled or not coupled with performance data.

### Machine Learning Model Training and Validation

Replicated routes may be employed to train or validate machine-learning models designed to predict human performance metrics such as effort, pace, or energy expenditure across different terrain conditions. Because each replicated route preserves measurable route attributes, including elevation gain/loss, grade distribution, and terrain type and specifically the sequence of this route attributes, the resulting datasets provide consistent, high-quality input for learning models. These models can use replicated route data to estimate performance outcomes under varying conditions or to improve prediction accuracy of pace, effort, fatigue resistance, or impacts of fatigue and environment conditions on effort. In some embodiments, replicated routes may also be used to identify data gaps or biases within existing performance datasets, supporting the development of more robust and terrain-aware predictive algorithms.

### Performance Metrics and Analytical Modeling

In some embodiments the processor's replicated routes 2008 may also be used to generate or refine performance metrics that quantify user efficiency, endurance, or fatigue modeling across comparable routes. By analyzing replicated routes alongside original route data, the system can normalize environmental variables and generate fair, terrain-adjusted comparison values. For example, this technology may support the calculation of advanced metrics such as Grade-Adjusted Pace (GAP) and/or dynamic Fatigue Models based on cumulative gain and loss, elevation sequencing, and terrain transitions. In some embodiments, replicated route data allows for cross-analysis between different users' performances, producing standardized benchmarks for training load, recovery time, and relative efficiency independent of location.

### Customized and Adaptive Training Plans

In certain embodiments, replicated routes may be integrated into personalized training plans tailored to the user's goals and fitness profile. The system can analyze route attributes, such as total distance, elevation gain, surface type, and terrain technicality, to generate one or more training recommendations or exercise plans with one or more replicated routes in preparation for a future event. For example, an athlete training for a mountainous ultramarathon may receive long run routes designed to simulate the grade intensity and sequence of a target course using locally available terrain. Over time, feedback and performance data collected from these training sessions can be reintroduced into the system as a Secondary Input Dataset 2011, enabling continuous refinement of route recommendations and personalized adaptation of training intensity as well as predictive performance models.

### Bilocation Performance Comparison

In certain embodiments, the processor's replicated routes 2008 may be used for comparing one or more user performances across geographically distinct, but attribute equivalent routes (bilocation comparison). Using replicated routes, the system can match different users' performances across geographically distinct, yet attribute-similar, routes. A route with existing performances could be used to generate a replicated route in different locations with key similarities such as distance, elevation, and difficulty, thereby establishing a fair comparison framework. Once matched, users can view metrics such as completion time, average speed, elevation gain/loss, and effort score. This enables competitive or motivational interactions among users, fostering community engagement, and enhancing the social dimension of training.

In some embodiments, the Refinement Engine 2007 can access user feedback data as a Secondary Input Dataset 2011 to refine future replications. Such feedback mechanisms allow users to submit post-activity evaluations, such as route quality, obstacles encountered, or satisfaction ratings, which are then used to improve future replications. This crowdsourced refinement ensures that the system continuously adapts to real-world user experiences, improving both accuracy and user satisfaction across the network.

While the above embodiments have been described in detail for clarity, the system is not confined to these specifics. There are numerous alternative methods for implementing the functionality of the system. The disclosed examples are intended to be illustrative, not limiting.

What is claimed is:

1. A system comprising:
one or more processors; and
a computer-readable, non-transitory storage medium comprising instructions that when executed by the one or more processors, cause the one or more processors to execute steps comprising:
receive an input dataset containing route information of a primary route input;
receive one or more route attributes of the primary route input;
receive one or more route preferences;
receive one or more geographic search areas;
parse the input dataset to extract the one or more route attributes, wherein the one or more route attributes include one or more of distance, grade, elevation, curvature intensity, terrain type, or terrain technicality;
slice the input dataset into one or more sections based on variances in the one or more route attributes satisfying a threshold creating a processed input;
access one or more secondary datasets;
generate one or more replicated routes by combining one or more secondary route sections from the one or more secondary datasets, whose secondary route attributes correspond to the one or more route attributes of the primary route input, into the one or more continuous replicated routes;
score the one or more replicated routes based on similarity to the processed input; and
output a dataset representing the one or more replicated routes, including a similarity score, elevation profile, and route visualization.

2. The system of claim 1, wherein the one or more route attributes further comprises one or more of:
a distance of a route section;
a positive elevation grade of a route section;
a negative elevation grade of the route section;
a terrain surface type of the route section;
an elevation of the route section;
a terrain technicality of the route section; and
a curvature intensity of the route section.

3. The system of claim 1, wherein the one or more route preferences comprises one or more of:
a preferred start location;
a first preference that the one or more replicated routes share a start location and an end location;
a second preference that the one or more replicated routes do not share the start and the end location;
a third preference that the one or more replicated routes contain a turnaround point; and
a fourth preference that the one or more replicated routes repeat one or more secondary sections.

4. The system of claim 1, wherein generating the one or more replicated routes is based at least in part on weightings assigned to the one or more route attributes according to one or more prioritization conditions.

5. The system of claim 1, wherein the steps further comprise:
apply a natural-language processing to the input dataset to extract quantitative or qualitative route attributes, including at least one of distance, total elevation gain or loss, grade intensity, terrain type, or other route attributes.

6. The system of claim 1, wherein the input dataset comprises one or more of:
a structured route data including a plurality of location and elevation nodes creating a route through geographical space; or
an unstructured route data, including a sequence of one or more route attributes with no specific location or elevation.

7. The system of claim 1, wherein generating the one or more replicated routes comprises:
comparing the one or more route attributes of one or more sections of the input dataset against the one or more secondary route attributes of one or more secondary sections of the secondary dataset within a tolerance threshold for one or more route attributes;
selecting and combining matching sections from the secondary dataset to form the one or more continuous replicated routes; and
calculating the one or more similarity scores for each replicated route to identify routes most closely matching the input dataset.

8. The system of claim 1, wherein the one or more processors generate the one or more replicated routes by:
querying the one or more secondary databases for one or more secondary sections, each of the one or more secondary sections comprising the one or more secondary route attributes;
identifying matching route sections within the tolerance threshold of the received one or more route attributes within a one or more geographic search areas defined;
propagating from each identified matching route section bidirectionally through a graph-based route network, wherein a forward propagation and a backward propagation each extend along adjacent route sections having route attribute values within the tolerance until an accumulated propagated distance satisfies the distance of a corresponding route section from the input dataset;
storing forward propagation results in a first set and backward propagation results in a second set;
combining said first set and said second set through cross-propagation to generate route combinations that collectively represent potential matching routes;
calculating, for each of said potential matching routes, the similarity score based on an alignment of the one or more route attributes of the input dataset with the one or more route attributes of the one or more replicated routes.

9. The system of claim 1, wherein the processor generates the one or more replicated routes by:
accessing one or more machine-learning models trained on Geographic Information System datasets comprising one or more route attributes including distance, positive elevation grade, negative elevation grade, terrain surface type, elevation, terrain technicality, and curvature intensity, wherein the training data includes a broader range of route attributes than those used in any single replication process, thereby improving predictive accuracy when replicating only a subset of route attributes;
analyzing one or more secondary sections of one or more secondary datasets with the machine-learning model to identify correlations and dependencies between the one or more secondary route attributes of the one or more secondary route sections of the one or more replicated route and the one or more route attributes or the one or more route sections or the input dataset;
applying the trained model to evaluate the likelihood of matching route sections being contiguous, and attribute-compatible with adjacent sections;
predicting one or more optimal combinations of matching route sections that collectively satisfy the prioritized route attributes while maintaining geographic continuity; and
generating the one or more replicated routes that balance proportional distribution of route attributes and topographic continuity relative to the input route.

10. The system of claim 1, wherein the processor assists in route refinement by:
adjusting the one or more route attributes of the one or more replicated routes to further align with the route attributes, preferences and prioritization conditions of the primary route input;
allowing users to manually adjust the one or more replicated routes;
displaying visual aids depicting route attribute targets of adjacent sections to a section being adjusted or added to the replicated route;
enabling the start and finish of an input route to be selected or cropped, to replicate only a portion of the input dataset; and
recalculating the one or more similarity scores based on adjustments.

11. The system of claim 1, wherein the one or more replicated routes:
preserves the sequence and proportional distribution, of said route attributes throughout the replicated route;
scales the length of individual route sections such that the replicated route maintains similar patterns and proportions of distance, grade, elevation, curvature intensity, terrain type, terrain technicality, or other route attributes to those of the input route but over a shorter or longer total distance; and
receives the one or more similarity scores representing proportional distribution of the one or more route attributes between the input and the replicated routes.

12. A system of claim 1, wherein the processor is further configured to:
format the replicated route to include geographical coordinates, waypoints, elevation data, and other data compatible with GPS-enable devices including smartwatches, smartphones, bike computers and dedicated outdoor navigation devices;
format the replicated route to integrate with external mapping or fitness applications; and
export the formatted replicated route to a computing device, smartwatches, bike computers, smartphones, or GPS-enabled devices.

13. A method comprising:
receiving, by one or more processors, an input dataset containing route information of a primary route input;
receiving, by the one or more processors, one or more route attributes of the primary route input;
receiving, by the one or more processors, one or more route preferences;
receiving, by the one or more processors, one or more geographic search areas;
parsing, by the one or more processors, the input dataset to extract the one or more route attributes, wherein the one or more route attributes include one or more of distance, grade, elevation, curvature intensity, terrain type, or terrain technicality;
slicing, by the one or more processors, the input dataset into one or more sections based on variances in the one or more route attributes satisfying a threshold;
accessing, by the one or more processors, one or more secondary datasets;
generating, by the one or more processors, one or more replicated routes by combining one or more secondary route sections from the one or more secondary datasets whose route attributes correspond to the input dataset into the one or more continuous replicated routes;
scoring, by the one or more processors, the one or more replicated routes based on similarity to the input dataset and processed input; and
outputting, by the one or more processors, a dataset representing the one or more replicated routes including a similarity score, elevation profile, and route visualization.

14. The method of claim 13, further comprising:
applying, by the one or more processors, a natural-language processing to the input dataset to extract quantitative or qualitative route attributes, including at least one of distance, total elevation gain or loss, grade intensity, terrain type, or other route attributes.

15. The method of claim 13, wherein the input dataset comprising one or more of:
a structured route data including a plurality of location and elevation nodes creating a route through geographical space; or
an unstructured route data, including a sequence of one or more route attributes with no specific location or elevation.

16. The method of claim 13, wherein generating the one or more replicated routes comprising:
comparing the one or more route attributes of one or more sections of the input dataset against the one or more secondary route attributes of one or more secondary sections of the secondary dataset within a tolerance threshold for one or more route attributes;
selecting, by the one or more processors, and combining matching sections from the secondary dataset to form the one or more continuous replicated routes; and
calculating, by the one or more processors, the one or more similarity scores for each of the one or more replicated routes to identify routes that most closely matching the input dataset.

17. The method of claim 13, wherein the one or more processors generating the one or more replicated routes:
querying the one or more secondary databases for one or more secondary sections, each of the one or more secondary sections comprising secondary route attributes;
identifying matching route sections within the tolerance threshold of the received one or more route attributes within a one or more geographic search areas defined;
propagating from each identified matching route section bidirectionally through a graph-based route network, wherein a forward propagation and a backward propagation each extend along adjacent route sections having route attribute values within the tolerance until an accumulated propagated distance satisfies the distance of a corresponding route section from the input dataset;
storing forward propagation results in a first set and backward propagation results in a second set;
combining said first set and said second set through cross-propagation to generate route combinations that collectively represent potential matching routes;
calculating, for each of said potential matching routes, the similarity score is based on an alignment of the one or more route attributes of the input dataset with the one or more route attributes of the one or more replicated routes.

18. The method of claim 13, wherein the one or more processors generating the one or more replicated routes:
accessing one or more machine-learning models trained on Geographic Information System datasets comprising one or more route attributes including distance, positive elevation grade, negative elevation grade, terrain surface type, elevation, terrain technicality, and curvature intensity, wherein the training data includes a broader range of route attributes than those used in any single replication process, thereby improving predictive accuracy when replicating only a subset of route attributes;
analyzing one or more secondary sections of one or more secondary datasets with the machine-learning model to identify correlations and dependencies between the one or more secondary route attributes of the one or more secondary route sections of the one or more replicated route and the one or more route attributes or the one or more route sections or the input dataset;
applying the trained model to evaluate the likelihood of matching route sections being contiguous, and attribute-compatible with adjacent sections;
predicting one or more optimal combinations of matching route sections that collectively satisfy the prioritized route attributes while maintaining geographic continuity; and
generating the one or more replicated routes that balance proportional distribution of route attributes and topographic continuity relative to the input route.

19. The method of claim 13, wherein the one or more replicated routes further comprising:
preserving, by the one or more processors, the sequence and proportional distribution, of said route attributes throughout the replicated route;
scaling, by the one or more processors, the length of individual route sections such that the replicated route maintains similar patterns and proportions of distance, grade, elevation, curvature intensity, terrain type, terrain technicality, or other route attributes to those of the input route but over a shorter or longer total distance; and
receiving, by the one or more processors, the one or more similarity scores representing proportional distribution of the one or more route attributes between the input and the replicated routes.
